(19) United States
(12) Patent Application Publication
(10) Pub. No.: US 2021/0235701 A1
(43) Pub. Date: Aug. 5, 2021

(54) METHOD AND SYSTEM FOR PREPARING HYPOCHLOROUS ACID SOLUTIONS WITH PROLONGED SHELF-LIFE

(71) Applicant: Emmett Manuel CUNNINGHAM, Glen Allen, VA (US)

(72) Inventor: Emmett Manuel CUNNINGHAM, Glen Allen, VA (US)

(21) Appl. No.: 16/972,543

(22) PCT Filed: Jun. 5, 2019
(86) PCT No.: PCT/US2019/035658

§ 371 Date: Dec. 4, 2020

Related U.S. Application Data
(60) Provisional application No. 62/681,584, filed on Jun. 6, 2018.

(51) Int. Cl. A01N 59/00; C01B 11/04; C01B 11/06; B01J 19/24

(52) U.S. Cl. CPC A01N 59/00; B01J 19/24; C01B 11/064; C01B 11/04

(57) ABSTRACT

The invention relates generally to disinfecting solutions and, more particularly, to systems and methods for producing disinfecting solutions having a prolonged shelf life. One embodiment provides a system comprising: a dispensing device; a chlorine-containing liquid or powder contained within the dispensing device; a container affixed to the dispensing device; and a receiving liquid within the container, wherein the dispensing device is adapted to deliver the chlorine-containing liquid or powder directly into the container.

### CROSS-REFERENCE TO RELATED APPLICATIONS

This application claims the benefit of co-pending US Provisional Patent Application Ser. No. 62/681,584, filed Jun. 6, 2018, which is hereby incorporated herein as though fully set forth.

### BACKGROUND

Since its inception in the 1700s, solutions of Hypochlorous acid (HOCl) have been known as strong disinfectants. Whether chemically or electro-mechanically made, Hypochlorous acid solutions have a very short period of use and therefore are not amenable to long term storage.

For example, 1000 ppm at pH 6 on day one will have depleted to under 500 ppm at pH 7.5 in 30 days. The solution to this problem, of course, would be to prepare the disinfectant fresh on the day it is to be used. However, this would require having on hand, for example, strong bleach (10-12.5% at a pH of 11.5-12), acid (e.g., muriatic), bottles, and caps, and would require a secure area to mix the chemicals, measuring devices, gloves, goggles, breathing apparatus, EPA-approved facility, and permit. All of this creates a hazardous work place for the end user. Alternatively, one could purchase, from an EPA-approved manufacturer, an EPA-registered disinfectant that is safe to handle and at full strength, on the day it is to be used. There are and have been several products that offer sodium dichloroisocyanurate in tablet/powder form to make Hypochlorous acid liquids by mixing with water, but, it still requires handling the raw material (Calcium hypochlorite) and mixing it correctly. The problem with this application is not in mixing it too week, but in mixing it to strong. If it works at 1000 ppm then it will really work at 5000 ppm and that can be a problem and not approved as an environmentally safe and effective product under EPA or any International regulatory agency.

As such, the industry has longed for a safe an effective Hypochlorous acid disinfectant that would maintain shelf stability for more than a few weeks, but, for 2-3 years. Household bleach (NaClO) has long been available and used to create disinfection solutions, but the shelf stability of bleach is a function of its extremely high pH, (11-12) which preserves the chlorine, albeit in a form not available for effective disinfection. As a disinfectant, Hypochlorous acid has a 10 to 1 stronger killing power than Bleach and much safer to use.

Therefore, this invention is intended to create, a long term shelf life (2-3 years), an end user safe product, correct volume and disinfection strength (in accordance with all EPA regulations) and the safe disposal of it's remains.

### SUMMARY

An embodiment of the invention provides a system for preparing a Hypochlorous acid solution, the system comprising: a dispensing device; a chlorine-containing liquid or powder contained within the dispensing device; a container affixed to the dispensing device; and a receiving liquid within the container, wherein the dispensing device is adapted to deliver the chlorine-containing liquid or powder directly into the container.

Another embodiment of the invention provides a method of preparing a Hypochlorous acid solution, the method comprising: dispensing from a dispensing device into a container containing a receiving liquid a quantity of a chlorine-containing liquid or powder; and agitating the combined receiving liquid and chlorine-containing liquid or powder to produce a Hypochlorous acid solution.

### DETAILED DESCRIPTION

As used herein, the terms “shelf-stable” or “shelf stability” refer to the ability of a solution to maintain a high proportion of its original disinfecting power for a particular period of time. A solution deemed “shelf-stable” for one month, for example, would retain at least about 80-90% of its original disinfecting power one month after production, assuming storage at normal room temperature and in the absence of strong light. In today's marketplace, that is no longer acceptable. For a product to be acceptable commercially, it needs to be stable and useable for more than a year, preferably for up to two to three years.

The invention employs a “dispensing cap” to store and later dispense the correct amount of the primary chemical, which can be safely and precisely pre-measured, eliminating any possible exposure to an end user or incorrectly mixing the desired strength approved by the EPA. The primary chemical is a chlorine-based powder or liquid, which can be directly transferred from the dispensing cap into an attached container (e.g., a bottle) containing a receiving liquid within which the primary chemical may be dispersed or dissolved, producing a liquid Hypochlorous acid solution.

The receiving liquid may be mildly acidic and is pre-measured and adapted to produce a hospital grade of Hypochlorous acid solution capable of killing up to 99.99% of bacteria contacted. It can, also, be dosed to create a milder household disinfectant capable of killing 99.9% of the contacted bacteria. In both cases the end user never touches the raw chemicals.

After releasing the contents of the dispensing cap and shaking the container holding the combined receiving liquid and primary chemical, the resulting Hypochlorous acid solution has a substantially neutral pH of 6-7 pH. A pH in this range would be safe for handling by an end user and also safe for transport or disposal.

The container holding the receiving liquid, and in which the Hypochlorous acid solution is prepared, as well as the dispensing cap, are typically formed of a plastic material impervious to the chemicals they hold and will last several years (e.g., at least about three years). The resulting Hypochlorous acid solution has been deemed safe for disposal in the normal course of use, including in a sink drain or toilet for delivery into any septic or sewer system, and has been deemed safe for all aquatic life at EPA-approved levels.

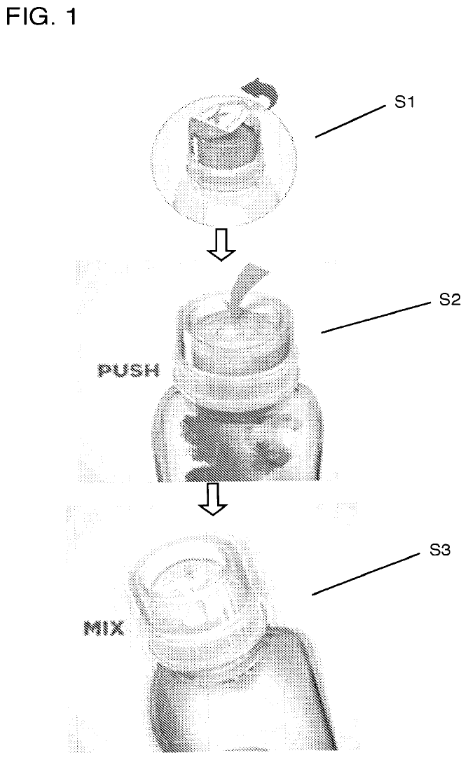

In one embodiment, illustrated in FIG. 1, the invention uses a storage cap to house an amount of a chlorine-based powder. At S1, a locking device, such as a sealing label, tab, or internal cap may be removed from the storage cap. The locking device is adapted to prevent dispensation of the chlorine-based powder until removed.

At S2, the chlorine-based powder is dispensed (e.g., by pushing a plunger or similar mechanism in the storage cap) into the container to which the storage cap is affixed.

At S3 a receiving liquid within the container and the dispensed chlorine-based powder are mixed (e.g., by mechanical agitation, such as shaking) to produce the desired Hypochlorous acid solution, which is then suitable for use as a disinfectant.

According to some embodiments, the chlorine-based powder is sodium dichloro-s-triazinetrione dihydrate and the receiving liquid is water. In other embodiments, the chlorine-based powder is calcium hypochlorite. In still other embodiments, chlorine-containing liquids, such as alkaline chlorine water (water chlorinated by chlorine gas), may be employed. The following examples are illustrative and are not intended to limit the scope of the invention.

### EXAMPLE 1

1.85 grams of sodium dichloroisocyanurate is dispensed into two liters of water and mixed to produce Hypochlorous acid at 850 ppm with a pH of about 6.5. The mixed solution is good for seven days at a strength capable of killing germs at a level of 99.99%. Stronger or weaker solutions (i.e., having a higher or lower ppm) may be prepared using a larger or a smaller quantity of sodium dichloroisocyanurate, as will be recognized by one skilled in the art.

### EXAMPLE 2

1 gram of calcium hypochlorite is dispensed into two liters of acidified water and mixed to produce Hypochlorous acid at 800-1000 ppm with a pH of about 6.5. The water is acidified by adding 0.3-1 gram of hydrochloric acid to create a pH of 2.5-4. This allows the alkaline-based calcium hypochlorite to react and produce a liquid at pH 6-7. The mixed solution is good for seven days at a strength capable of killing germs at a level of 99.99%. Again, stronger or weaker solutions may be prepared using a larger or a smaller quantity of calcium hypochlorite.

### EXAMPLE 3

0.3-1 grams of alkaline chlorine water (water chlorinated by chlorine gas to 12% by volume) is dispensed into two liters of acidified water and mixed to produce Hypochlorous acid at 800-1000 ppm with a pH of about 6.5. The water is acidified by adding 0.3-1 gram of hydrochloric acid to create a pH of 2.5-4. The mixture is good for seven days at a strength capable of killing germs at a level of 99.99%. Again stronger or weaker solutions may be prepared using a larger or a smaller quantity of alkaline chlorine water and/or a more- or less-acidified water, as will be recognized by one skilled in the art.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A system for preparing a Hypochlorous acid solution, the system comprising:
a dispensing device;
a chlorine-containing liquid or powder contained within the dispensing device;
a container affixed to the dispensing device; and
a receiving liquid within the container,
wherein the dispensing device is adapted to deliver the chlorine-containing liquid or powder directly into the container.

2. The system of claim 1, further comprising:
a locking device adapted to prevent dispensation of the chlorine-containing liquid or powder into the container.

3. The system of claim 1, wherein the container is removably affixed to the dispensing device.

4. The system of claim 3, wherein the receiving liquid includes water.

5. The system of claim 4, wherein the water includes water purified by at least one process selected from a group consisting of: steam distillation, micron filtration, reverse osmosis, and ozonization.

6. A method of preparing a Hypochlorous acid solution, the method comprising:
dispensing from a dispensing device into a container containing a receiving liquid a quantity of a chlorine-containing liquid or powder; and
agitating the combined receiving liquid and chlorine-containing liquid or powder to produce a Hypochlorous acid solution.

7. The method of claim 6, wherein the chlorine-containing powder includes sodium dichloroisocyanurate.

8. The method of claim 6, wherein the receiving liquid has an acidic pH.

9. The method of claim 8, wherein the receiving liquid includes at least one acid selected from a group consisting of: hydrochloric acid, sulfuric acid, phosphoric acid, nitric acid, acetic acid, boric acid, hydrofluoric acid, oxalic acid, citric acid, sulfamic acid, and carbonic acid.

10. The method of claim 9, wherein the receiving liquid has a pH of between about 2.5 and about 5.5 and includes sulfuric acid.

11. The method of claim 6, wherein the chlorine containing powder includes calcium hypochlorite.

12. The method of claim 11, wherein the receiving liquid has an acidic pH.

13. The method of claim 11, wherein the receiving liquid includes at least one acid selected from a group consisting of: hydrochloric acid, sulfuric acid, phosphoric acid, nitric acid, acetic acid, boric acid, hydrofluoric acid, oxalic acid, citric acid, sulfamic acid, and carbonic acid.

14. The method of claim 13, wherein the receiving liquid has a pH of between about 2.5 and about 5.5 and includes acetic acid.

15. The method of claim 6, wherein the receiving liquid includes water.

16. The system of claim 15, wherein the water includes water purified by at least one process selected from a group consisting of: steam distillation, micron filtration, reverse osmosis, and ozonization.

17. The method of claim 6, further comprising:
removing from the dispensing device a locking device adapted to prevent dispensing of the chlorine-containing liquid or powder into the container.
